(19) United States
(12) Patent Application Publication
(10) Pub. No.: US 2014/0310680 A1
(43) Pub. Date: Oct. 16, 2014

(54) System And Method For Collaboration

(71) Applicant: Massively Parallel Technologies, Inc., Boulder, CO (US)

(72) Inventor: Kevin D. Howard, Tempe, AZ (US)

(73) Assignee: Massively Parallel Technologies, Inc., Boulder, CO (US)

(21) Appl. No.: 14/253,626

(22) Filed: Apr. 15, 2014

Related U.S. Application Data
(60) Provisional application No. 61/812,138, filed on Apr. 15, 2013.

(51) Int. Cl. G06Q 10/10; G06F 9/44

(52) U.S. Cl. CPC G06Q 10/101; G06F 8/30
USPC 717/102

(57) ABSTRACT

A System and a method implement a first collaboration between a first group of developers working at a first location within a hierarchical workspace and a second collaboration between a second group of developers working at a second location within the hierarchical workspace. The first collaboration is generated in association with the first location, and for each of the first group of developers, a first collaboration screen in communication with the first collaboration is generated. Information is conveyed between each of the first collaboration screens. The second collaboration is generated in association with the second location, and for each of the second group of developers, a second collaboration screen in communication with the second collaboration is generated. Information is conveyed between each of the second collaboration screens.

### RELATED APPLICATIONS

This application claims priority to U.S. Patent Application Ser. No. 61/812,138, titled “System and Method for Collaboration”, filed Apr. 15, 2013, and incorporated herein by reference.

### BACKGROUND

Many work activities require collaboration and interaction. Unfortunately, existing online collaboration tools, though adequate for conferencing, lecturing and meeting, are not designed as an interactive workspace tool.

### SUMMARY OF THE INVENTION

A collaboration system enables developers living and working in geographically diverse areas to work together by improving communication between the developers. Within a parallel processing design environment, this model of audio and video interaction is called “collaboration”. Video conferencing methods are enhanced to simultaneously allow independent collaborations for different parts of the same work environment. A developer is automatically switched from one collaboration to another as they move between working locations of the workspace. Collaboration includes the following modalities: privilege-based collaboration participation, automatic workspace collaboration switching (individual and group), collaboration observer modes (observer status and ghosting), automatic transport to another developer's location, whisper modes (audio and audio/video), simultaneous workspace object manipulation (visible and invisible objects), multi-linguistic audio automatic language translation, adjacent-workspace developer-presence indicator, and text object collaboration.

In one embodiment, a system allows collaboration between a plurality of developers having simultaneous access to a hierarchical workspace. The system includes a management server with a non-transitory memory and a processor. A collaborator, having machine readable instructions stored the memory and executable by the processor, capable of facilitating: a first collaboration between a first two of the plurality of developers working at a first location of the hierarchical workspace; and a second collaboration between a second two of the plurality of developers working at a second location of the hierarchical workspace, wherein the first two and the second two developers are each different from one another.

In another embodiment, a method implements a first collaboration between a first group of developers accessing a first location within a hierarchical workspace and a second collaboration between a second group of developers accessing a second location within the hierarchical workspace. The first collaboration is generated in association with the first location, and for each of the first group of developers, a first collaboration screen in communication with the first collaboration is generated. Information is conveyed between each of the first collaboration screens. The second collaboration is generated in association with the second location, and for each of the second group of developers, a second collaboration screen in communication with the second collaboration is generated. Information is conveyed between each of the second collaboration screens.

In another embodiment, a software product has instructions, stored on non-transitory computer-readable media, wherein the instructions, when executed by a computer, perform steps for implementing a first collaboration between a first group of developers working at a first location within a hierarchical workspace and a second collaboration between a second group of developers working at a second location within the hierarchical workspace. The software product includes instructions for generating the first collaboration in association with the first location; instructions for generating, for each of the first group of developers, a first collaboration screen in communication with the first collaboration; instructions for conveying information between each of the first collaboration screens; instructions for generating the second collaboration in association with the second location; instructions for generating, for each of the second group of developers, a second collaboration screen in communication with the second collaboration; and instructions for conveying information between each of the second collaboration screens.

### BRIEF DESCRIPTION OF THE FIGURES

FIG. 1 shows one exemplary parallel processing development environment, in an embodiment.

FIG. 2 shows one exemplary hierarchical decomposition diagram.

FIG. 3 shows one exemplary collaboration screen illustrating video, observers, instant messaging, and collaborative pointer.

FIG. 4 shows one exemplary collaboration screen illustrating an active developer list.

FIG. 5 shows one exemplary collaboration screen illustrating an audio whisper mode request.

FIG. 6 shows one exemplary collaboration screen illustrating an audio whisper mode acceptance.

FIG. 7 shows one exemplary collaboration screen illustrating an audio/video whisper request.

FIG. 8 shows one exemplary collaboration screen illustrating and audio/video mode acceptance.

FIG. 9 shows one exemplary collaboration screen illustrating multiple collaborative pointers in simultaneous action.

FIG. 10 shows one exemplary collaboration screen illustrating text to speech conversion.

FIG. 11 shows one exemplary collaboration screen illustrating an occupied indication with developer names.

FIG. 12 shows one exemplary collaboration screen illustrating collaboration text activity.

FIG. 13 is a flowchart illustrating one exemplary method for collaboration, in an embodiment.

### DETAILED DESCRIPTION OF THE EMBODIMENTS

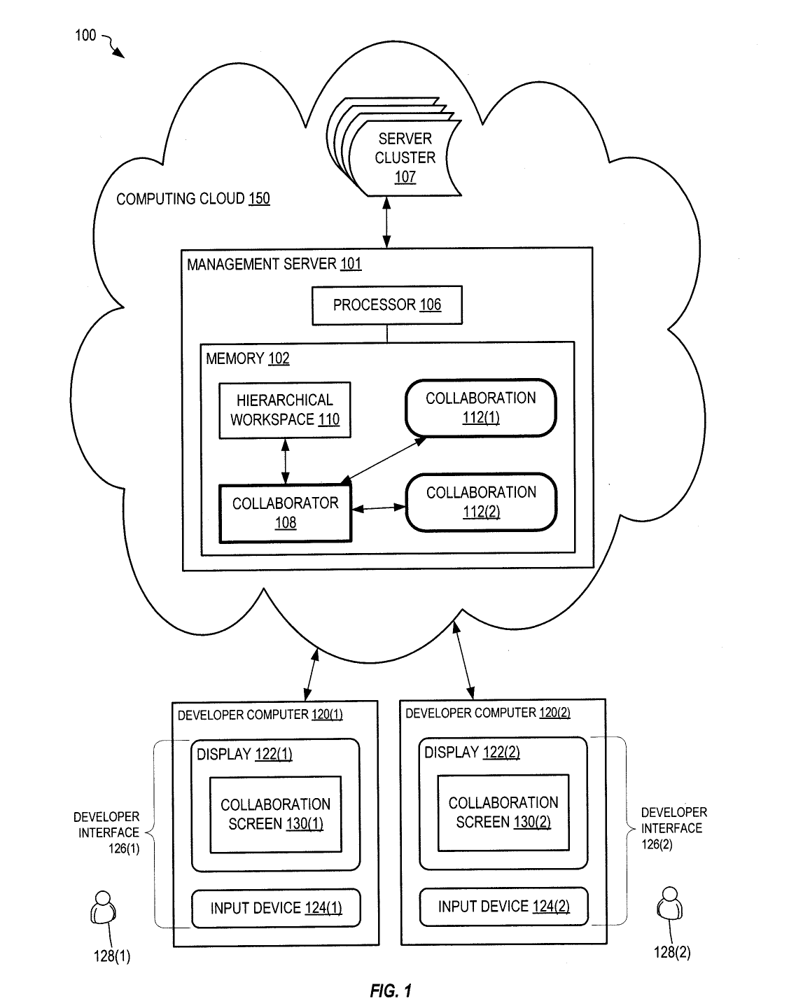

FIG. 1 shows one exemplary parallel processing development environment 100. Within system 100, a management server 101 provides access to a server cluster 107 of processing nodes. Management server 101 includes a memory 102 (e.g., RAM, ROM, magnetic media, optical media, a database, and one or more data structures) and a processor 106. As shown in FIG. 1, management server 101 and server cluster 107 may operate within a computing cloud 150. A first developer 128(1) uses a developer computer 120(1) to access (e.g., via the Internet and/or other networking system) management server 101, wherein developer 128(1) is provided a developer interface 126(1) on developer computer 120(1). Developer interface 126(1) is for example implemented using a display 122(1) and an input device 124(1) of developer computer 120(1).

Similarly, a second developer 128(2) uses a developer computer 120(2) to access (e.g., via the Internet and/or other networking system) management server 101, wherein developer 128(2) is provided a developer interface 126(2) on developer computer 120(2). Developer interface 126(2) is for example implemented using a display 122(2) and an input device 124(2) of developer computer 120(2).

The first and second developers 128 interact with developer interface 126 to access and manipulate a hierarchical workspace 110 within management server 101. For example, each of the first and second developers 128 may develop software within hierarchical workspace 110. Management server 101 includes a collaborator 108 having machine readable instructions that are executed by processor 106 to implement at least one collaboration 112 between the developers 128.

Collaborator 108 generates one collaboration 112 for each different location (e.g., a development location) within hierarchical workspace 110 that is accessed by one or more developer interfaces 126. Collaborator 108 generates a collaboration screen 130 for each developer interface 126 joining collaboration 112. In one example of operation, collaborator 108 may generate collaboration 112(1) for a first location within hierarchical workspace 110 that is accessed by (e.g., viewed, created, and/or modified by) developer interface 126(1) of first developer 128(1) using computer 120(1). Collaborator 108 generates collaboration screen 130(1) on developer computer 120(1) that allows the first developer 128(1) to interact with collaboration 112(1). Where developer interface 126(2) also accesses the first location of hierarchical workspace 110, collaborator 108 generates collaboration screen 130(2) on developer computer 120(2) that allows the second developer 128(2) to interact with collaboration 112(1). Thereby, the first and second developer 128 may communicate with each other through collaboration 112(1).

Collaborator 108 may simultaneously generate other collaborations 112 for each different location within hierarchical workspace 110 that is accessed by other developers. For example, wherein developer interface 126(2) accesses a second location within hierarchical workspace 110, collaborator generates collaboration 112(2) in association with the second location and generates collaboration screen 130(2) such that the second developer 128(2) may interact with collaboration 112(2).

As each developer moves to different locations (e.g., different hierarchical levels and/or different locations within the same hierarchical level) within workspace 110, collaboration screen 130 is automatically disconnected from, and connected to, the appropriate collaboration 112.

### Decomposition and Workspace Conferencing

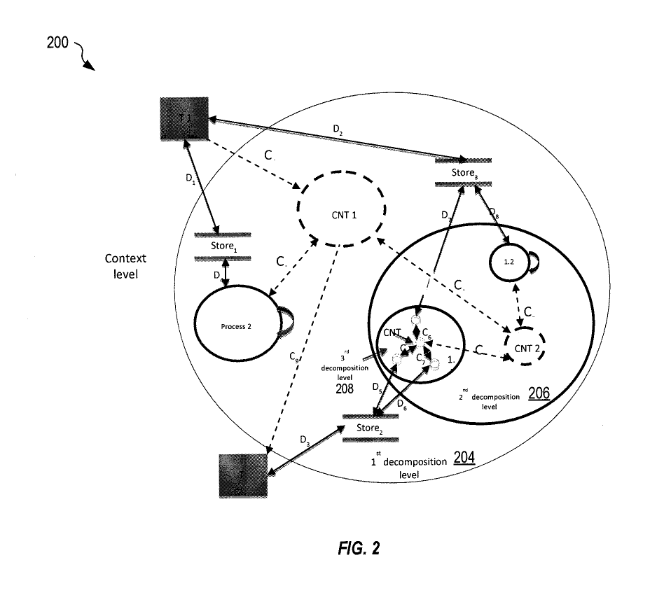

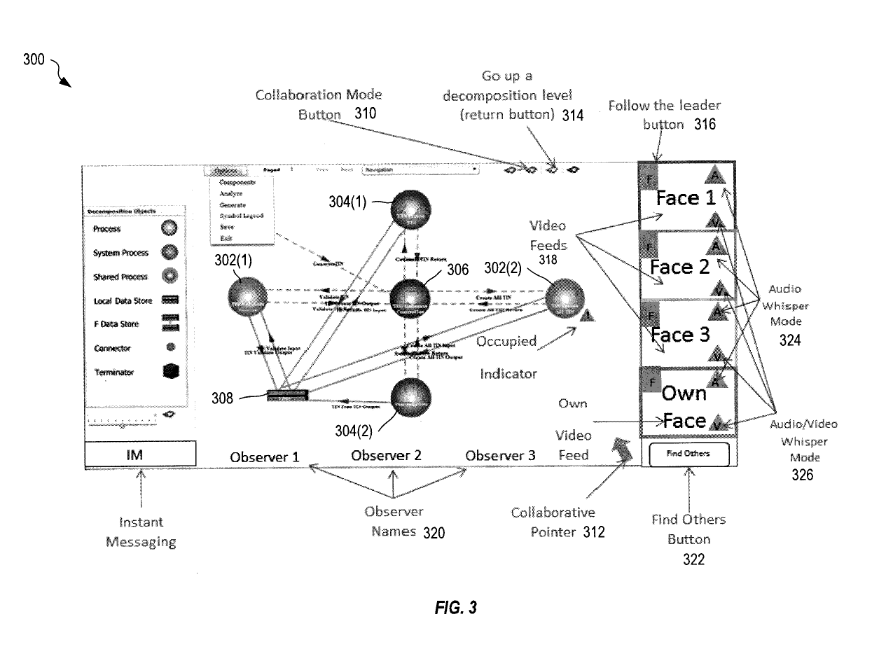

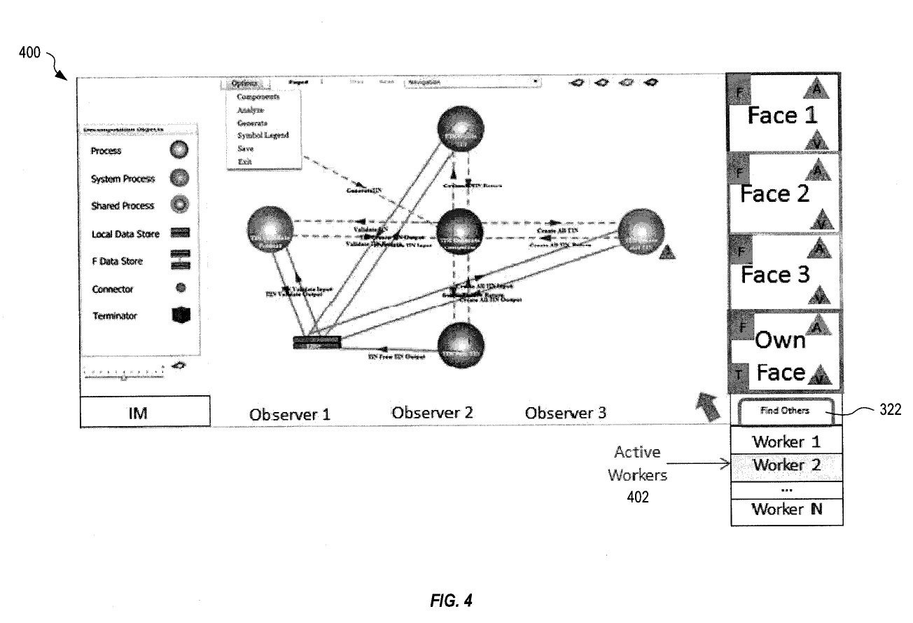

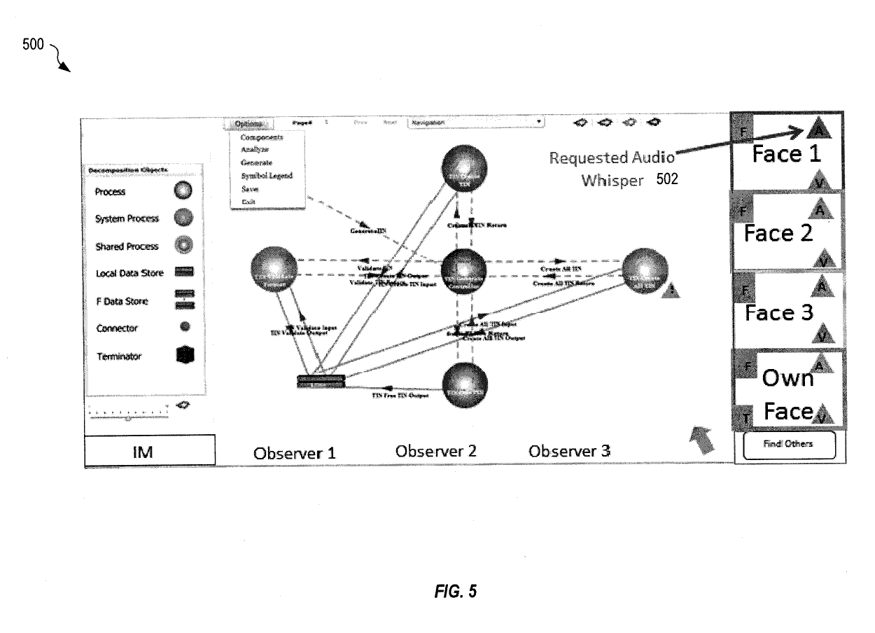

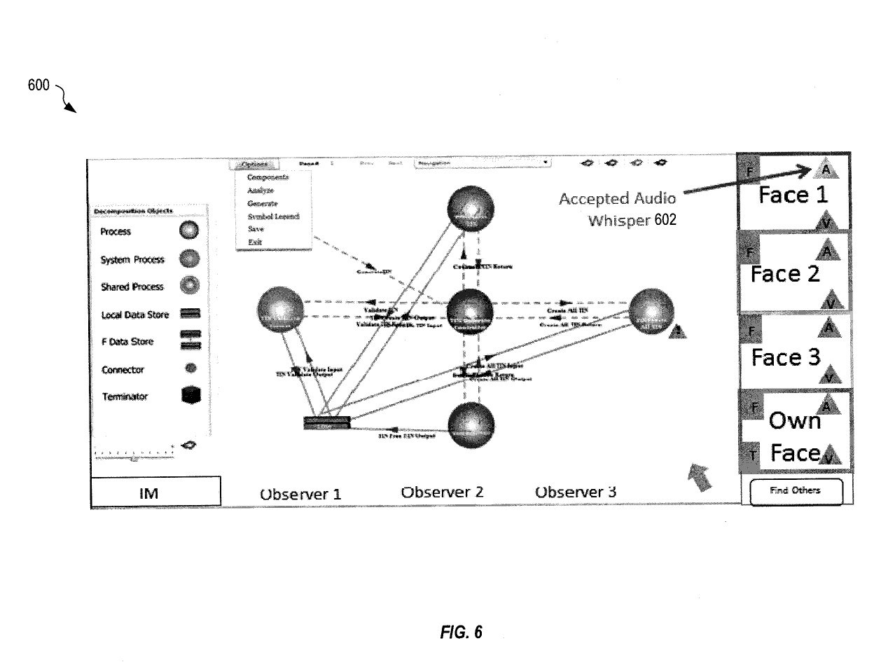

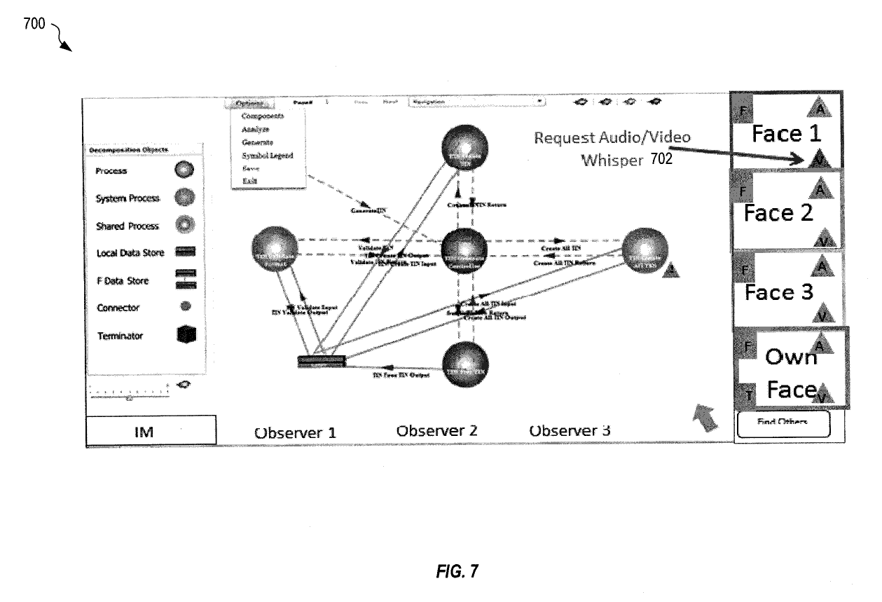

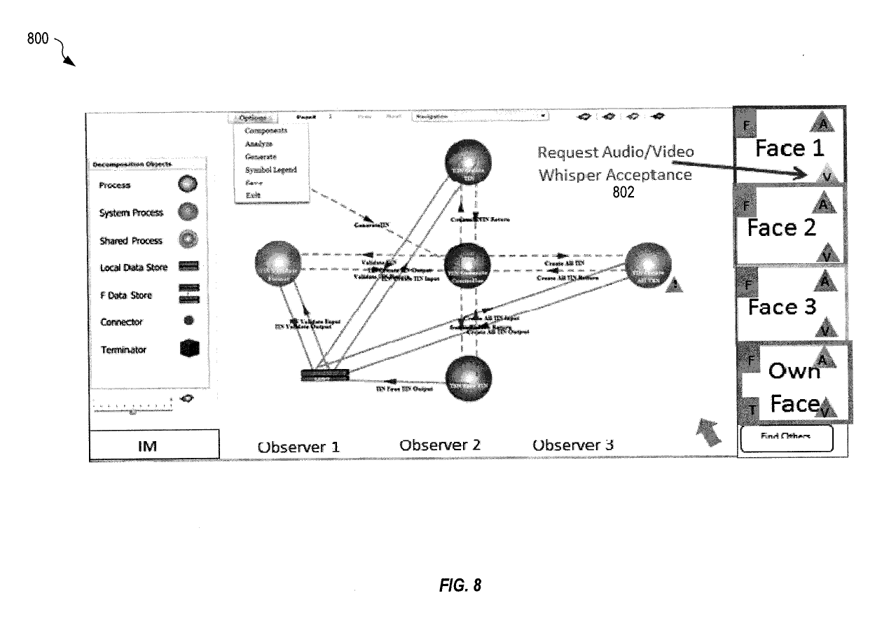

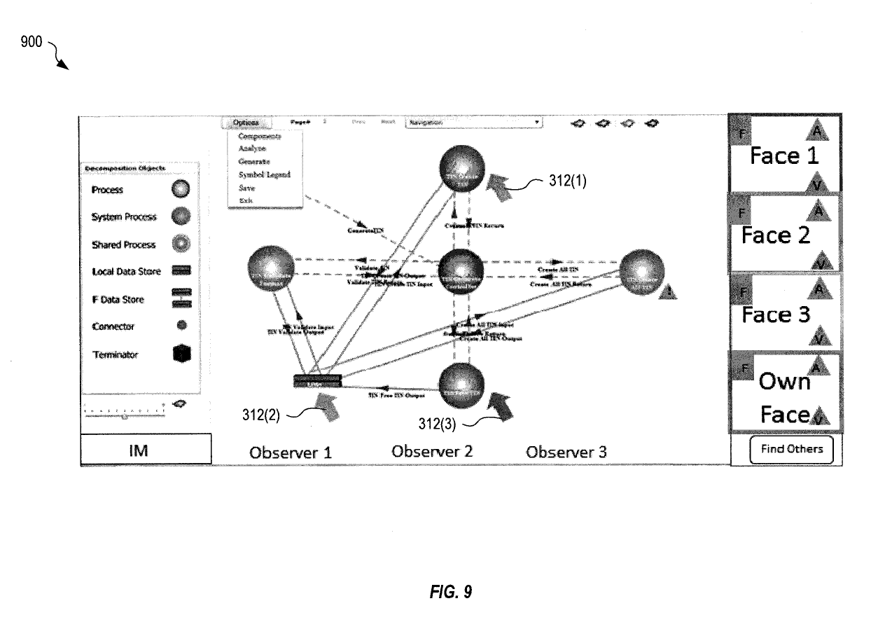

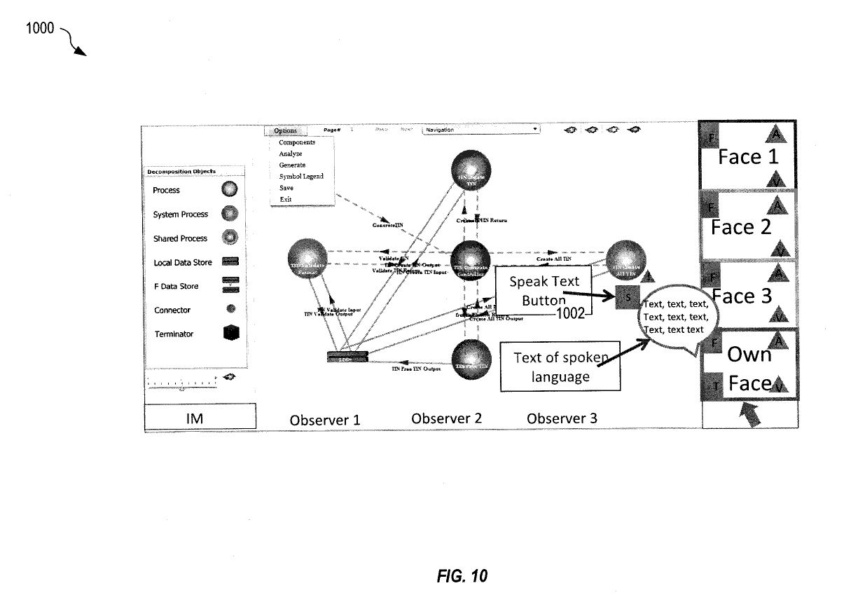

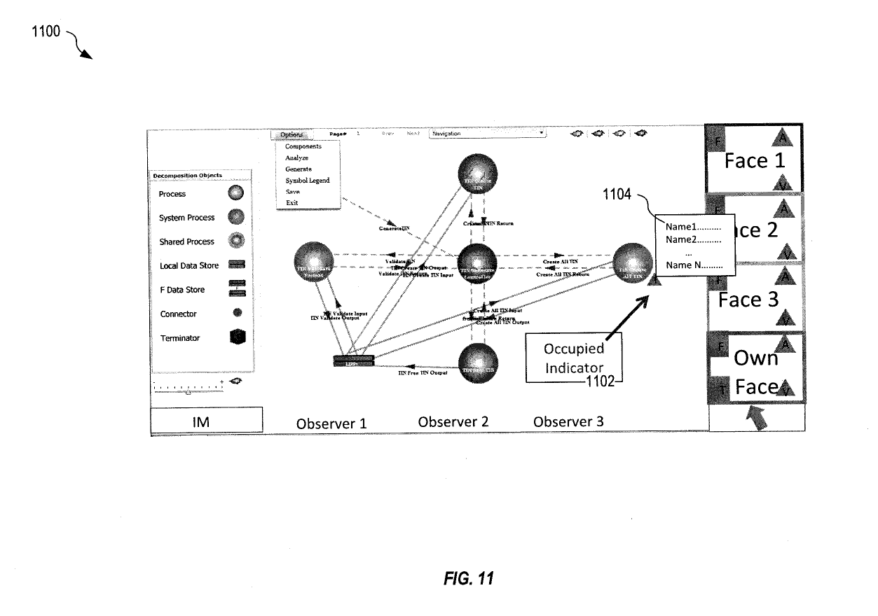

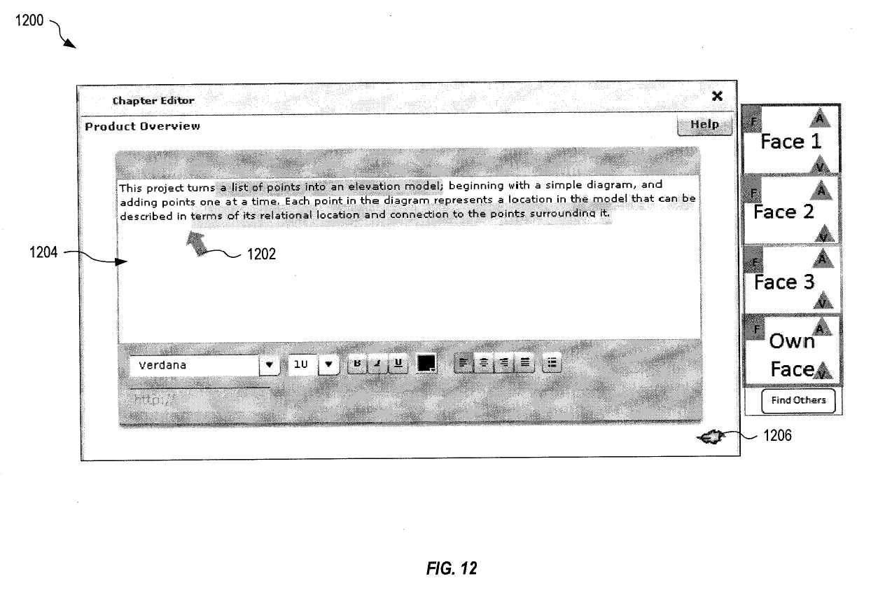

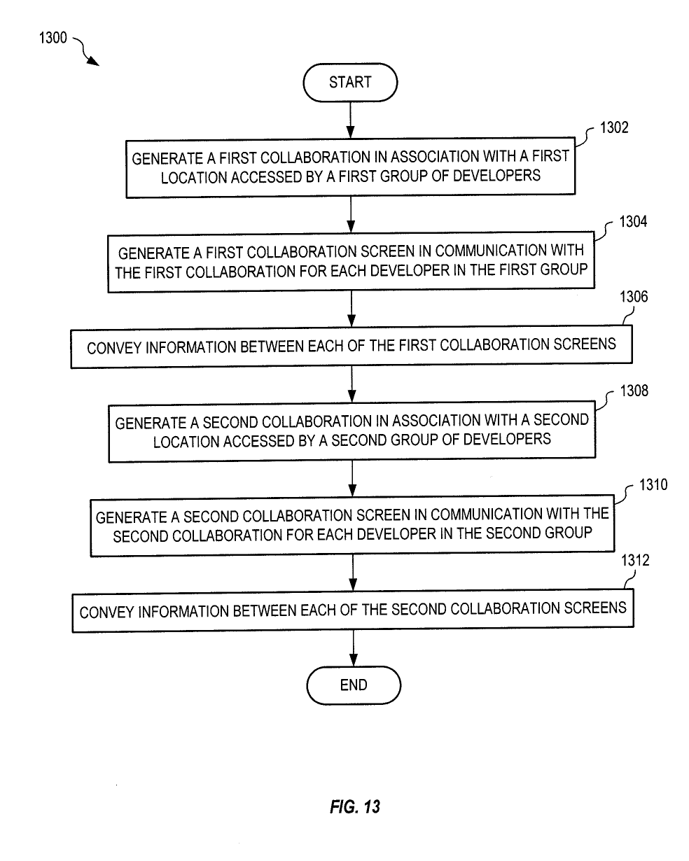

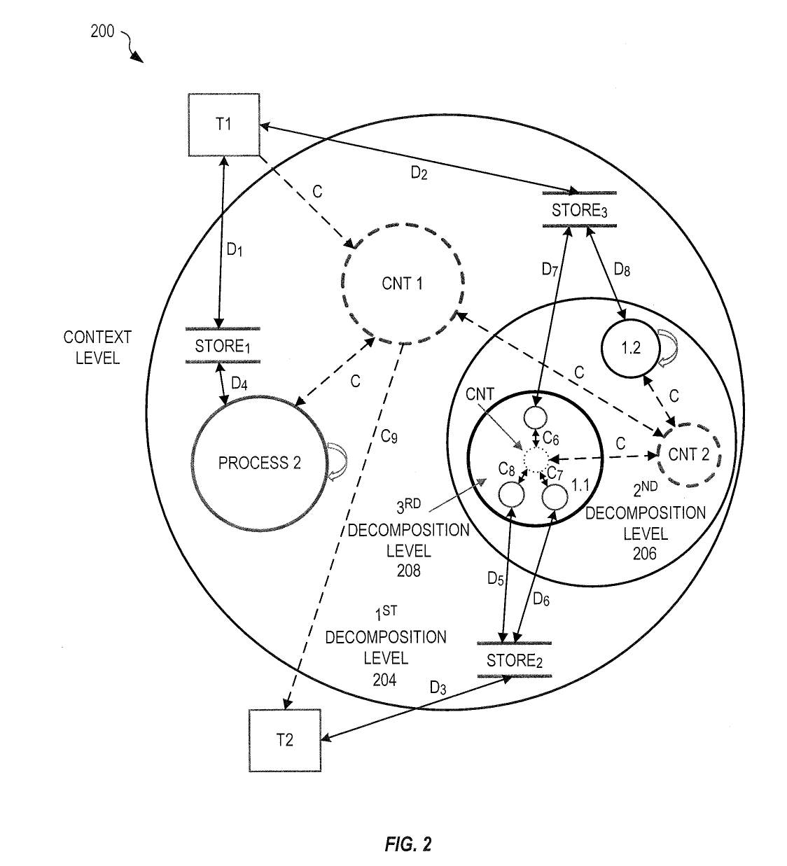

FIG. 2 shows one exemplary hierarchical decomposition diagram 200 that represents at least a part of hierarchical workspace 110 of FIG. 1. Dashed lines represent control flows, solid lines represent data flows, dashed circles represent control transforms, solid circles represent process transforms, parallel lines represent data stores, and squares represent terminators. It is possible to have collaboration at the Context level 202, 1st decomposition level 204, 2nd decomposition level 206, or 3rd decomposition level 208. Certain prior art video-conferencing models ignore the inherent hierarchical nature of hierarchical workspace 110 and allow only one area of collaboration for workspace 110. Collaborator 108 provides improvements to video and audio conferencing that improve collaboration within hierarchical workspace 110 by allowing concurrent collaborations 112 at different locations within hierarchical workspace 110.

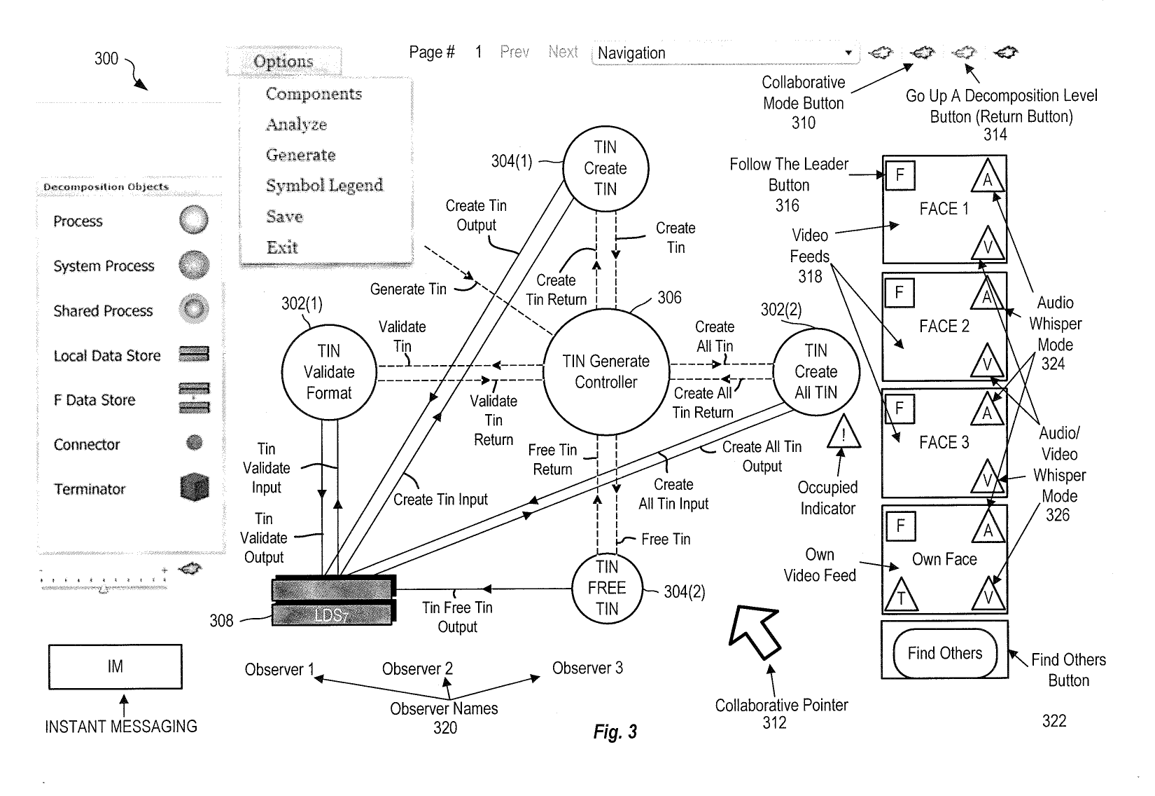

FIG. 3 shows one exemplary collaboration screen 300 illustrating hierarchical collaboration within hierarchical workspace 110 of FIG. 1. Selecting a Collaboration Model button 310 puts a developer in collaboration mode. On collaboration screen 300, a blue ball 302 represents a process of hierarchical workspace 110 that decomposes into a lower decomposition level, a green ball 304 represents a process of hierarchical workspace 110 that cannot decompose into a lower level, a red ball 306 represents a control process of hierarchical workspace 110 that does not decompose, and short wide parallel lines 308 represent a data store.

### Privilege-Based Collaboration Participation

A developer may not have full access to the certain processes and decomposition levels (which represent workspaces). Access to various workspaces may be controlled using access privileges. Access privileges are of three kinds: no access or no privileges, read-only access, and read-write access or edit privileges. A developer with a “no access” privilege to some workspace will not be able to enter that area and, thus, cannot participate in any collaboration occurring there. A developer with a “read-only” privilege is not allowed to modify items within that workspace but is able to see the video transmissions and hear the audio but does not have audio-video output capability, nor do they have access to a collaborative pointer 312. That developer may, however, use instant messaging to communicate with anyone they wish. Developers with “edit” privileges have audio/video feeds, whisper-mode access, instant messaging, and access to their own collaborative pointers 312.

### Automatic Workspace Collaboration Switching

In the example of FIG. 3, the developer moves down a decomposition level by double left-clicking on a particular process (green ball 304 or blue ball 302). Selecting the yellow-leaf (return) button 314 allows the developer to move up one decomposition level. When the developer moves up or down a decomposition level, they may collaborate on that decomposition level according to their assigned privilege settings. Developers left behind on the prior level do not appear at the current level unless they also move to this level. This concept may operate for any separate part of system 100. In essence, whenever a developer moves from one distinct part of hierarchical workspace 110 to another, that developer potentially enters into a collaboration at that location.

### Automatic Workspace Collaboration Group Switching

For developers with edit privileges, it is possible to move multiple members of one collaboration to a different part of system 100. A developer requests that others move with him by selecting the Follow the Leader button 316 associated with their video feeds 318. Selecting the Follow the Leader button316 is a request to follow, causing these buttons of the same name on the selected video feeds to indicate the request to developers associated with the feeds. Each developer then selects his own Follow the Leader button 316, putting the developer in a follow-the-leader mode. Collaboration screen 300 indicates that the request is accepted by changing the button 316. A developer may leave follow-the-leader mode by de-selecting the Follow the Leader button 316. Double clicking a requesting Follow the Leader button 316 denies the request.

Once in follow-the-leader mode, any place within system 100 that the requester goes causes each developer within that group to follow to that collaborative location within hierarchical workspace 110. This allows a development team to remain cohesive while traversing multiple locations within system 100.

### Collaboration Observation Modes

A developer with a read-only privilege wishing to join the collaboration may only do so in observer mode. An administrator who would like to observe without being observed can select ghost mode.

### Observer Status Mode

The purpose of observer mode is to allow the observer to witness the development activities without participation. Developers in observer mode may see all collaboration video and hear all collaboration audio. However, they cannot initiate their own audio or video. An observer may communicate only through instant messaging. The observer's name 320 is shown on the workspace.

### Ghost Status Mode

Ghost mode allows management to observe development activities without being observed. This ensures that the work is not disrupted while giving management the information required to manage.

### Automatic Transport to Another Developer's Location

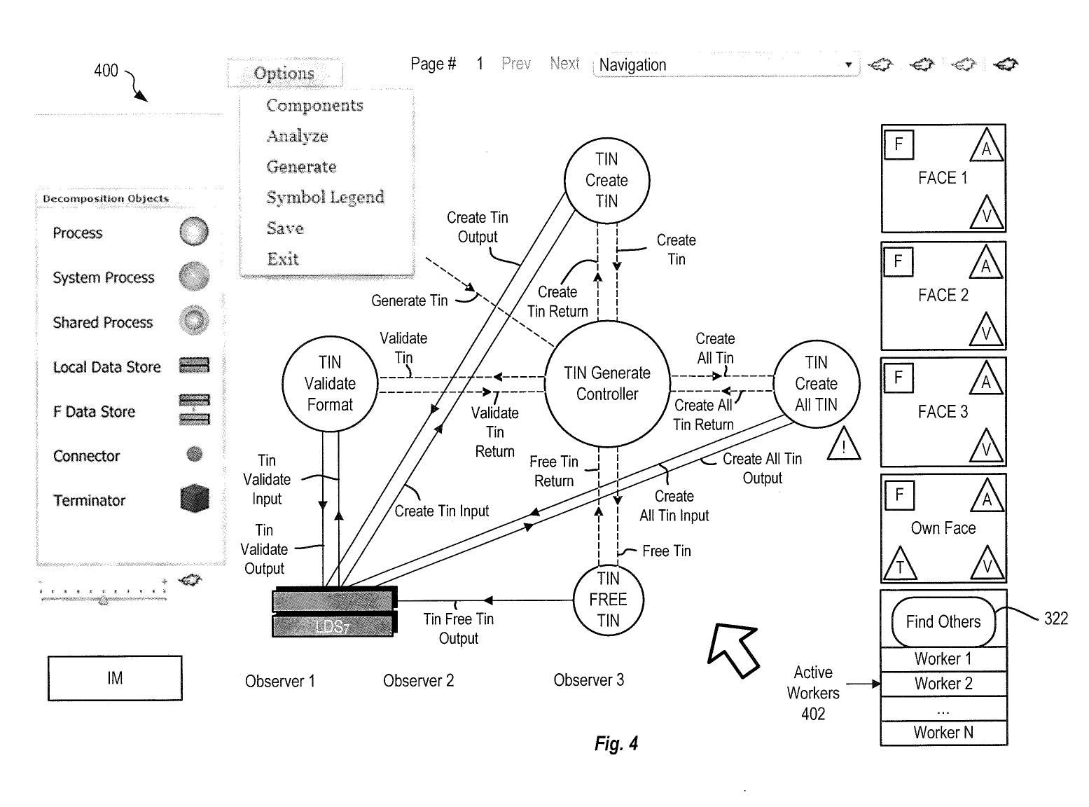

In larger systems, it can be difficult to determine the location of other developers. FIG. 4 shows one exemplary collaboration screen 400 with an active worker list 402 that drops down when the “Find Others” pull-down 322 is selected. Selecting a developer's name causes the current developer to be transported to the workspace in the system where the selected developer is currently is working.

### Whisper Modes

Having open communication within a collaboration at all times may be disruptive to the collaboration. Whisper mode allows communication among a subset of the collaboration attendees. Non-whisperers do not share in whispered communication. Essentially, a temporary sub-collaboration is created. Whisper mode can be audio only or audio and video.

### Audio Whisper Mode

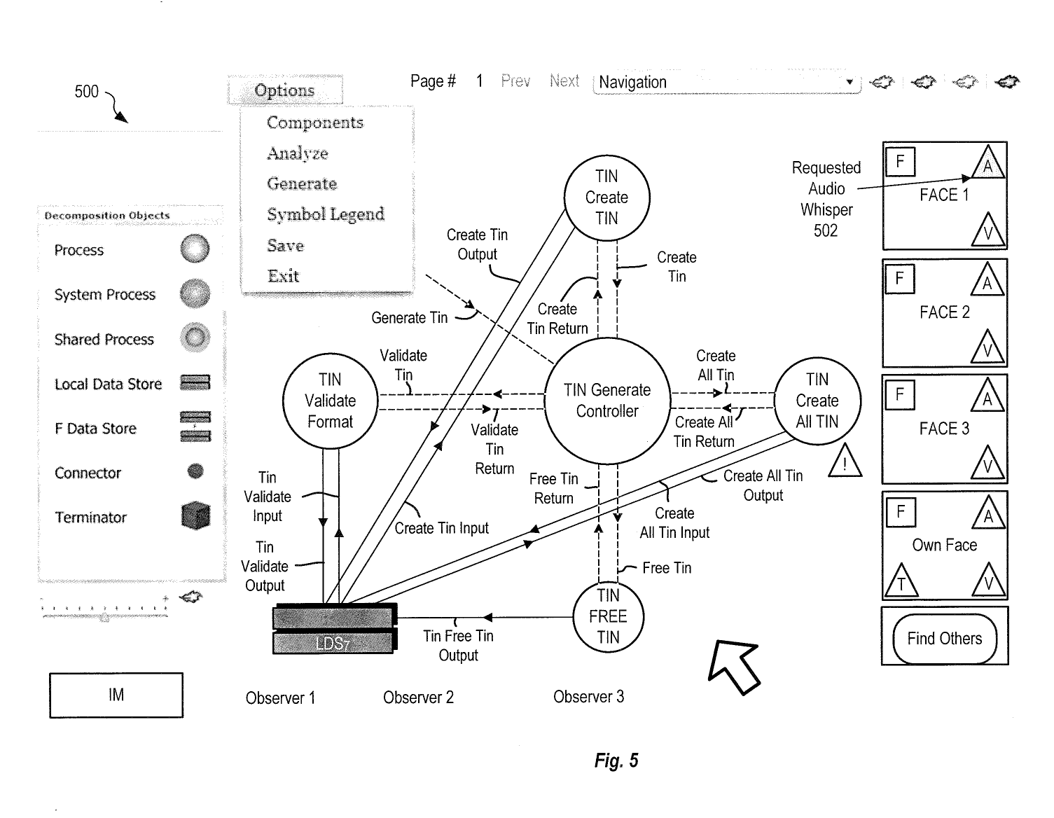

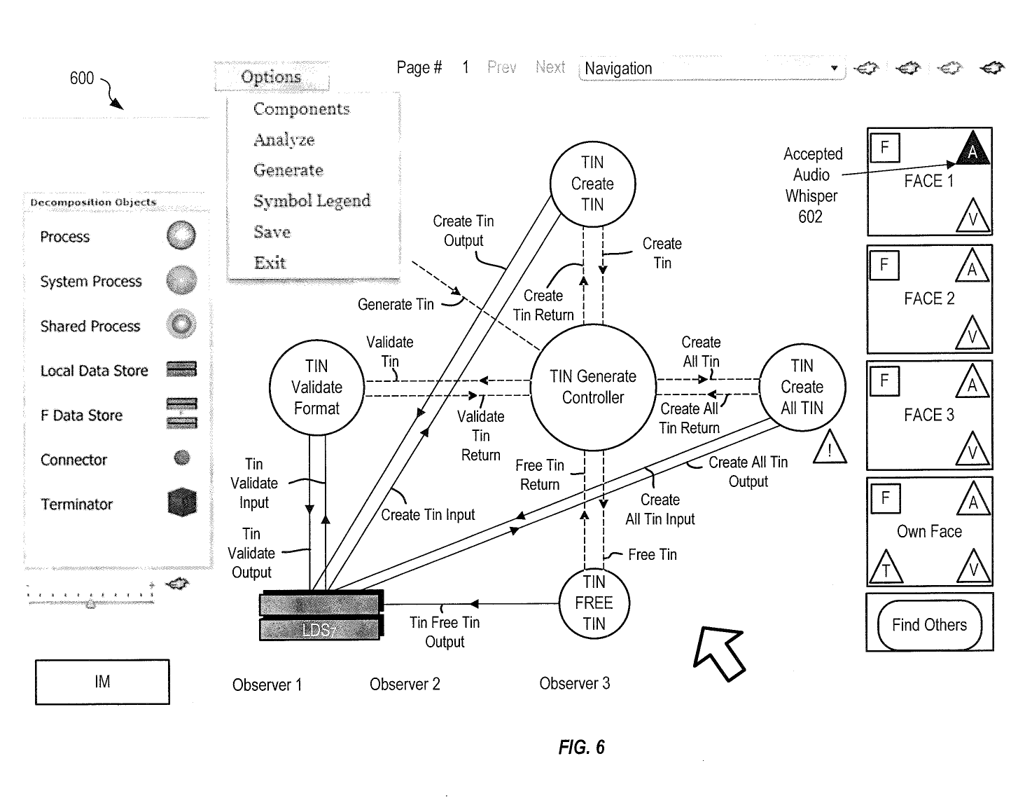

FIG. 5 shows one exemplary collaboration screen 500 illustrating an audio whisper mode request 502. FIG. 6 shows one exemplary collaboration screen 600 illustrating an audio whisper mode accept 602. Selection of the Audio Whisper button 324 attached to another developer's video feed 318 causes a request for audio whisper, which is indicated on the requested developer's Audio Whisper button 324. If the receiving developer selects his or her own Audio Whisper button then the audio-whisper mode between the two developers is engaged. Either developer de-selecting the button ends the audio-whisper mode. The audio-whisper mode causes only the audio between the whisperers to be audible; audio of the other collaboration participants is suppressed to the whisperers, and vice versa.

### Audio/Video Whisper Mode

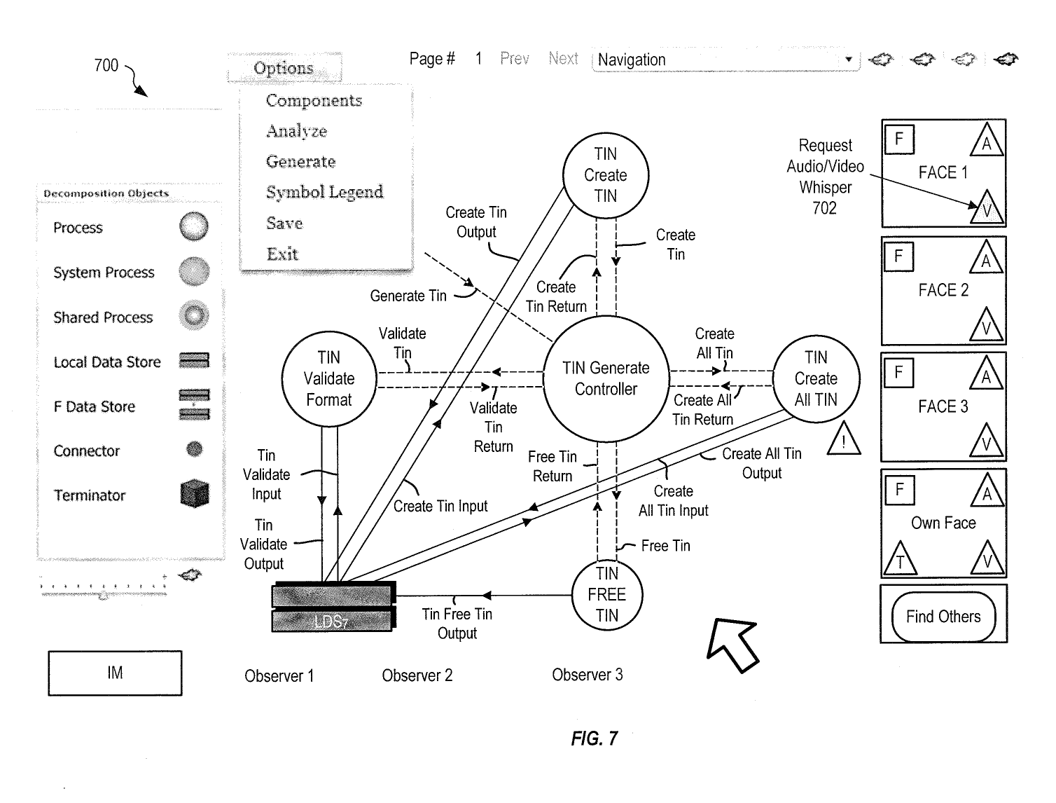

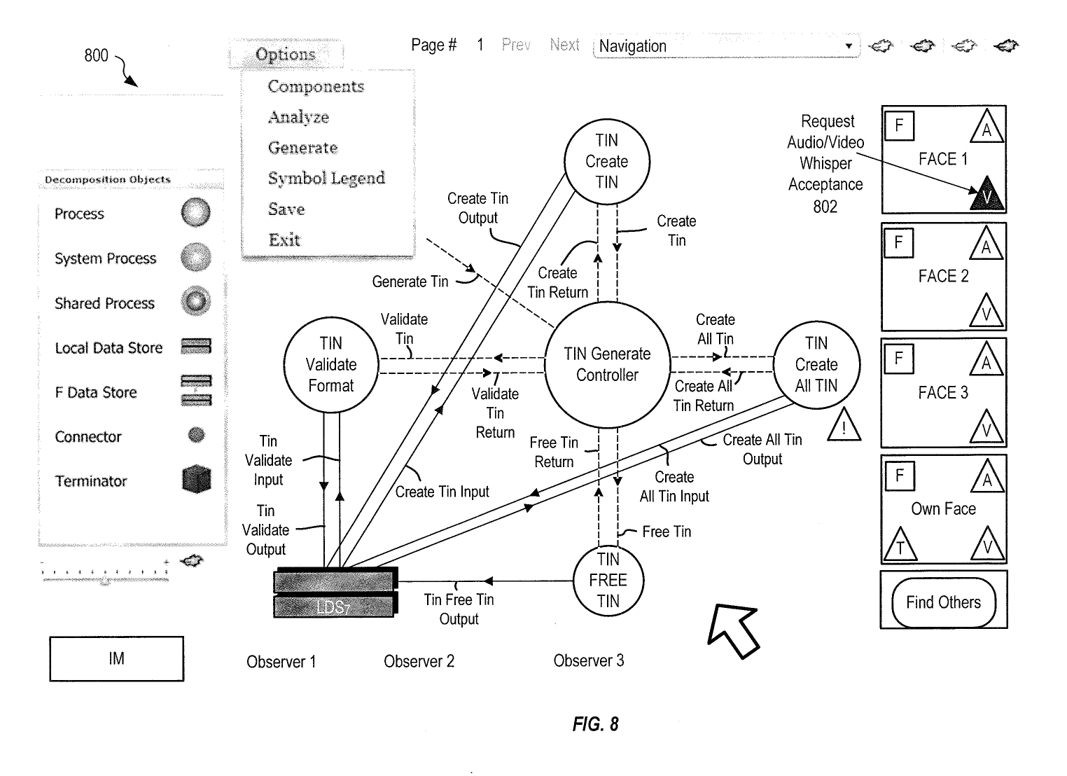

FIG. 7 shows one exemplary collaboration screen 700 illustrating an Audio/Video request 702. FIG. 8 shows one exemplary collaboration screen 800 illustrating an Audio/Video accept 802. Selection of the Audio/Video Whisper button 326 attached to another developer's video feed causes a request for audio/video whisper, which is indicated on the requested developer's button of the same name. If the requested developer selects his own Audio/Video Whisper button 326 then the audio/video-whisper mode between the two developers is engaged. Either developer de-selecting the button ends the audio/video-whisper mode. The audio/video-whisper mode causes the video feeds of the non-participating developers to gray out for the whisperers and causes the video feeds of the whisperers to gray out for the non-whisperers. Audio between the whisperers will be the only audio available to the whisperers. The whisperers will not be heard by the non-whisperers.

### Simultaneous Workspace Object Manipulation Modes

True collaboration implies that multiple developers may simultaneously access different objects within hierarchical workspace 110. Objects may be processes, data storage, terminators or connectors. The first developer to access a particular object retains that object until they release it.

### Visible Object Manipulation Mode

In order to access an object such that others in the collaboration can see the manipulation, the developer selects the collaborative pointer by clicking on a blank part of the workspace which changes the pointer to the same color as that surrounding the developer's own video feed. All collaborators can now see the initiating developer's collaborative pointer. Any action taken while using the collaborative pointer will be visible to all collaborators. To return to standard-pointer mode, the developer again selects a blank part of the workspace. FIG. 9 shows one exemplary collaboration screen 900 illustrating multiple collaborative pointers 312 in simultaneous action. The color of each pointer is the same as the box around the developer's video feed 318.

### Invisible Object Manipulation Mode

If the pointer is in standard mode but the developer is in collaboration mode then manipulating an object is invisible to the collaboration until the Submit button is selected. Once the Submit button has been selected, the object changes become visible to the collaboration. When in invisible-object manipulation mode, the collaborative activity performed by the other developers is not visible. This allows for complex manipulation of objects without such manipulations crowding the collaboration workspace with multiple, complex information.

### Multi-Lingual Audio Automatic Language Translation

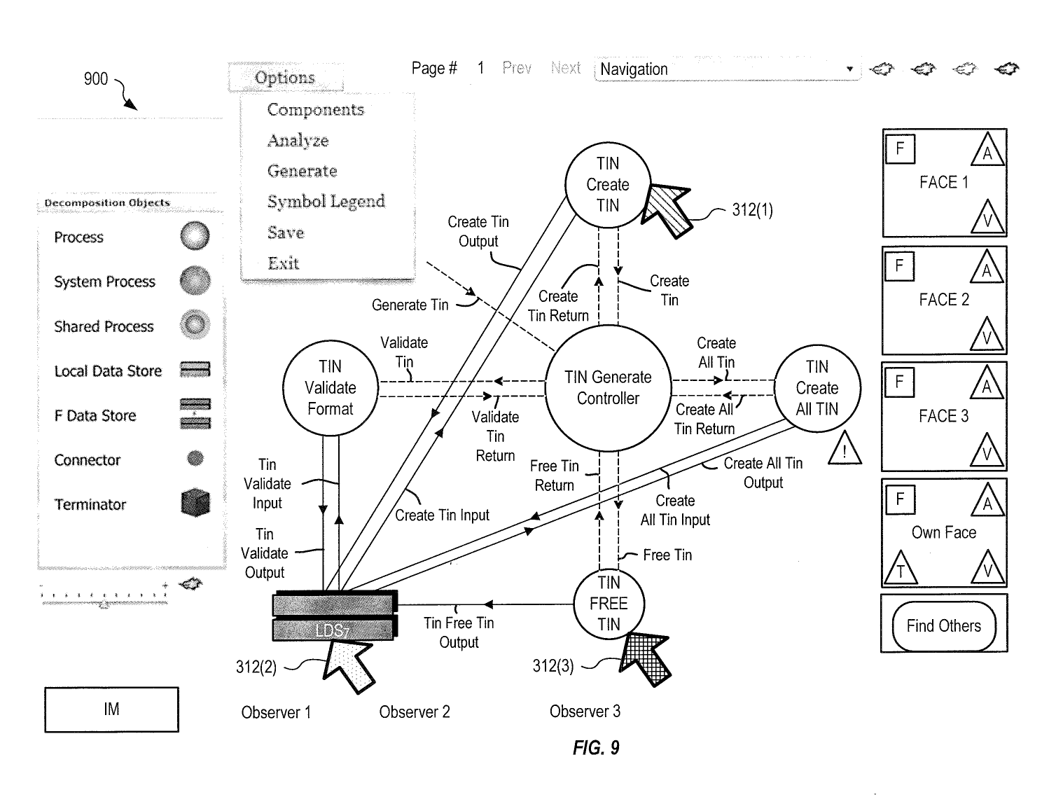

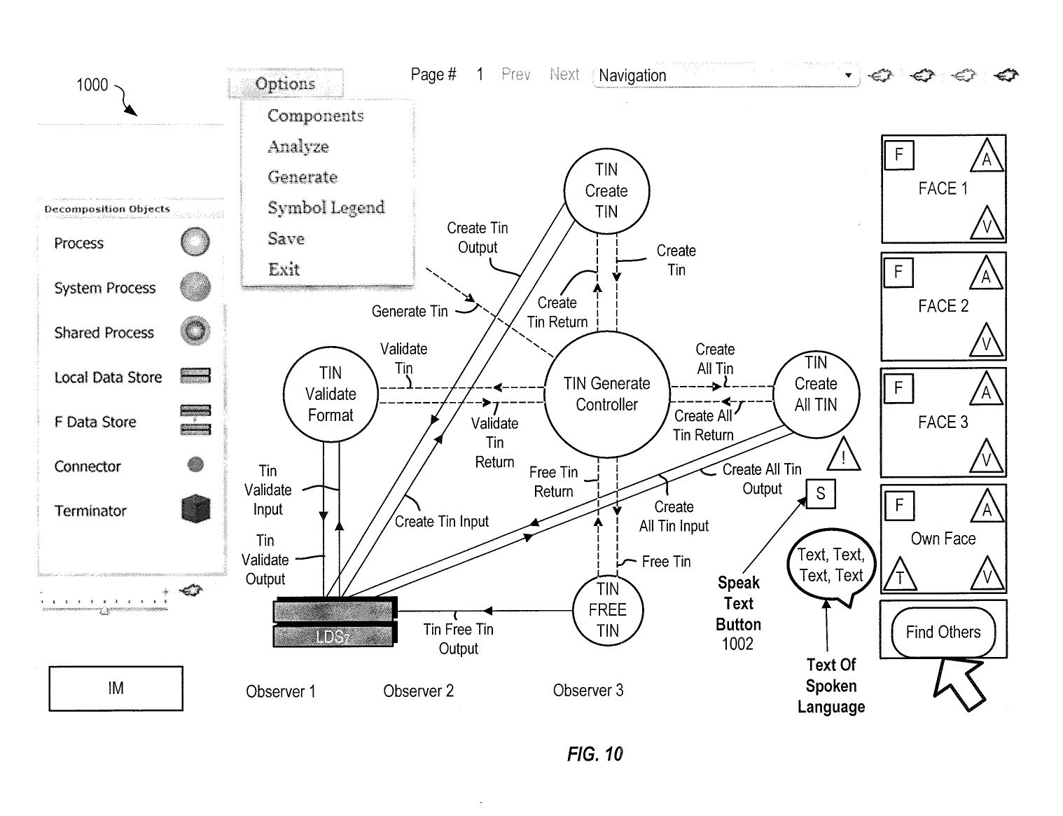

FIG. 10 shows one exemplary collaboration screen 1000 illustrating text to spoken language. When a developer signs up to use the system, s/he enters the language of preference. When in collaboration mode, the system checks the preferred language of each developer. If the developer selects the Translate button whenever he/she speaks, a text form of the spoken words is generated and displayed for the speaker, in the preferred language. The speaker reads the text and determines if what is written is what was intended. If what is written is not what was intended then the speaker can correct the text. If the speaker is satisfied with the text then he/she selects the Read Text button 1002. Each developer in collaboration then hears the translated version of the approved text, in his/her preferred language.

### Adjacent Workspace Developer Presence Indication

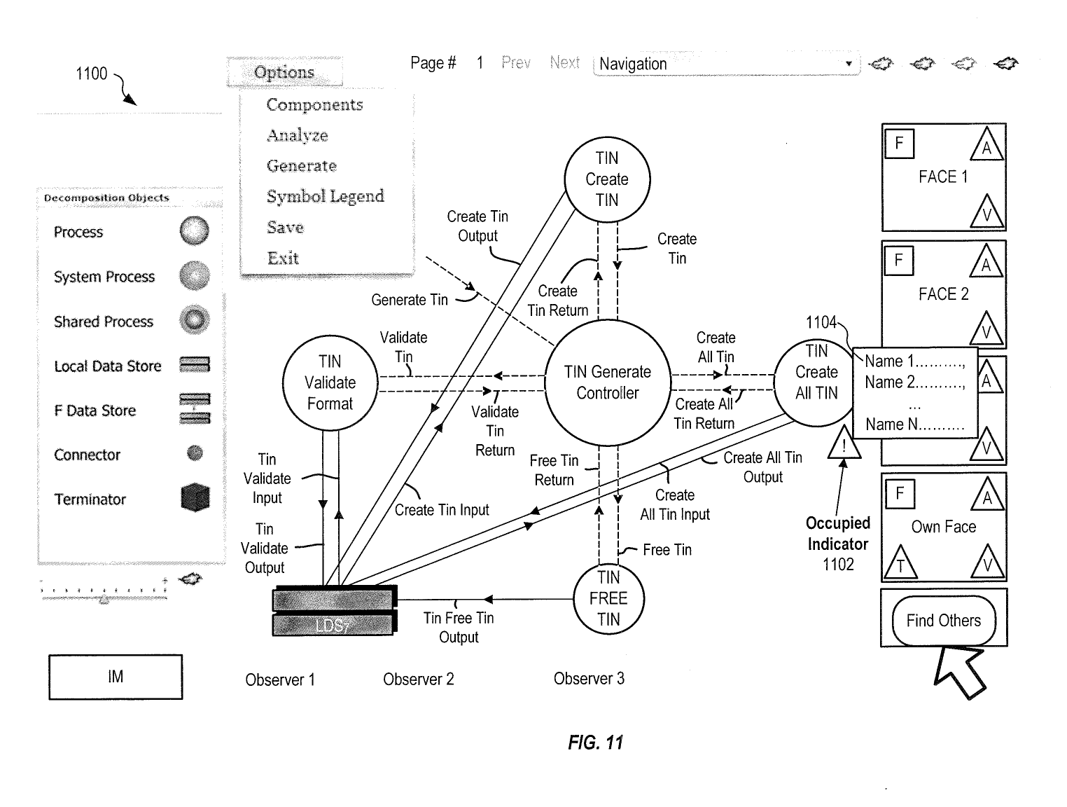

FIG. 11 shows one exemplary collaborative screen 1100 illustrating an occupied indicator 1102 and developer names 1104. The “occupied” indicator makes it possible to know if there are any developers at a lower decomposition level. Those objects with an associated occupied indicator 1102 have developers who are collaborating. Hovering the mouse pointer over the occupied indicator shows the names of the developers collaborating within the associated object.

Collaboration with Text Activities

Frequently, text-based activities require collaboration. Examples are source code and requirements-document writing. Text is typically flat, that is non-hierarchical, and therefore, the collaboration methods are different. FIG. 12 shows one exemplary collaboration screen 1200 illustrating a collaboration text activity. To collaborate on text activities, a developer, in collaboration mode, selects the standard pointer then clicks anywhere on the shared text screen 1204. This will show the current developer his or her own copy of the current text which he or she can modify as required. When finished with modifications, the developer selects the Submit button (green leaf) 1206 causing the next text to be merged with the existing text. If the collaboration pointer 1202 is used rather than the standard pointer, then any changes are made directly on the shared-text screen. Any text changes will be color-coded to the writer on the shared-text screen.

Collaboration may take place using a type of network including but not limited to star, ring, bus, frame-relay, local area, wide area, cell-phone, internet, centralized, decentralized, distributed, tree, botnet, etc.

### CONCLUSION

The systems and method for collaboration described above provide a collaborative work environment among people across the globe. New collaboration modalities discussed were: privilege-based collaboration participation, automatic workspace collaboration switching (individual and group), collaboration observer modes (observer status and ghosting), automatic transport to another developer's location, whisper modes (audio and audio/video), simultaneous workspace object manipulation (visible and invisible objects), multi-linguistic automatic language translation, adjacent-workspace developer-presence indicator, and text-object collaboration.

FIG. 13 is a flowchart illustrating one exemplary method 1300 for collaboration. Method 1300 is for example implemented within collaborator 108, FIG. 1. In step 1302, method 1300 generates a first collaboration in association with a first location accessed by a first group of developers. In one example of step 1302, collaborator 108 generates collaboration 112(1) in association with a first location of hierarchical workspace 110 and developer 128(1). In step 1304, method 1300 generates a first collaboration screen in communication with the first collaboration for each developer in the first group. In one example of step 1304, collaborator 108 generates collaboration screen 130(1) in communication with collaboration 112(1) for developer 128(1). In step 1306, method 1300 conveys information between each of the first collaboration screens. In one example of step 1306, collaborator 108 and collaboration 112(1) convey information between collaboration screen 130(1) and collaboration screen 130(2).

In step 1308, method 1300 generates a second collaboration in association with a second location accessed by a second group of developers. In one example of step 1308, collaborator 108 generates collaboration 112(2) in association with a first location of hierarchical workspace 110 and developer 128(2). In step 1310, method 1300 generates a second collaboration screen in communication with the second collaboration for each developer in the second group. In one example of step 1310, collaborator 108 generates collaboration screen 130(2) in communication with collaboration 112(2) for developer 128(2). In step 1312, method 1300 conveys information between each of the second collaboration screens. In one example of step 1312, collaborator 108 and collaboration 112(2) convey information between collaboration screen 130(2) and collaboration screen 130(1).

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A system for allowing collaboration between a plurality of developers having simultaneous access to a hierarchical workspace, comprising:
a management server having a non-transitory memory and a processor; and
a collaborator, comprising machine readable instructions stored the memory and executable by the processor, capable of facilitating:
a first collaboration between a first two of the plurality of developers working at a first location of the hierarchical workspace; and
a second collaboration between a second two of the plurality of developers working at a second location of the hierarchical workspace, wherein the first two and the second two developers are each different from one another.

2. The system of claim 1, wherein the first and second collaborations occur simultaneously and independently of one another.

3. The system of claim 1, wherein the collaborator automatically includes another one of the developers within the first collaboration when the one developer moves to the first location.

4. The system of claim 1, wherein the collaborator implements one or both of audio conferencing and video conferencing.

5. The system of claim 1, the first collaboration comprising a collaboration interface for each of the first two and the second two developers.

6. A method for implementing a first collaboration between a first group of developers accessing a first location within a hierarchical workspace and a second collaboration between a second group of developers accessing a second location within the hierarchical workspace, comprising:
generating the first collaboration in association with the first location;
generating, for each of the first group of developers, a first collaboration screen in communication with the first collaboration;
conveying information between each of the first collaboration screens;
generating the second collaboration in association with the second location;
generating, for each of the second group of developers, a second collaboration screen in communication with the second collaboration; and
conveying information between each of the second collaboration screens.

7. The method of claim 6, further comprising generating another collaboration screen in communication with the first collaboration for an additional developer that moves to the first location.

8. The method of claim 7, further comprising generating, within the first collaboration screens, a video feed from one or more developers of the first group.

9. The method of claim 7, further comprising generating, within the first collaboration screens, audio from one or more developers of the first group.

10. The method of claim 6, wherein the first and second collaborations operate independently and simultaneously.

11. The method of claim 6, further comprising forming a sub-collaboration to allow a sub-set of the first group of developers to communicate independently of other developers of the first group.

12. The method of claim 11, wherein the sub-collaboration comprises one or both of audio and video communication between the sub-set of developers.

13. The method of claim 6, further comprising generating a collaborative pointer within the first collaboration screen and under control of one developer of the first group.

14. The method of claim 6, further comprising:
transporting an additional developer to the first location when requested by one of the first group of developers; and
generating, for the additional developer, another collaboration screen in communication with the first collaboration.

15. The method of claim 6, further comprising:
receiving an indication of a leader of the first group of developers; and
transporting each of the developers of the first group to a third location within the hierarchical workspace when the indicated leader moves to the third location;
generating a third collaboration in association with the third location;
generating, for each of the first group of developers, a third collaboration screen in communication with the third collaboration; and
conveying information between each of the third collaboration screens.

16. A software product comprising instructions, stored on non-transitory computer-readable media, wherein the instructions, when executed by a computer, perform steps for implementing a first collaboration between a first group of developers working at a first location within a hierarchical workspace and a second collaboration between a second group of developers working at a second location within the hierarchical workspace, comprising:
instructions for generating the first collaboration in association with the first location;
instructions for generating, for each of the first group of developers, a first collaboration screen in communication with the first collaboration;
instructions for conveying information between each of the first collaboration screens;
instructions for generating the second collaboration in association with the second location;
instructions for generating, for each of the second group of developers, a second collaboration screen in communication with the second collaboration; and
instructions for conveying information between each of the second collaboration screens.

17. The software product of claim 16, further comprising instructions for generating another collaboration screen in communication with the first collaboration for an additional developer that moves to the first location.

18. The method of claim 16, further comprising instructions for generating, within the first collaboration screens, a video feed from one or more developers of the first group.

19. The method of claim 16, further comprising instructions for generating, within the first collaboration screens, audio from one or more developers of the first group.

20. The method of claim 16, wherein the first and second collaborations operate independently and simultaneously.
